(19) United States
(12) Patent Application Publication
(10) Pub. No.: US 2024/0243670 A1
(43) Pub. Date: Jul. 18, 2024

(54) POWER CONVERSION CIRCUIT, POWER CONVERSION SYSTEM, AND METHOD OF CONTROLLING THE SAME

(71) Applicant: ARK MICROELECTRONIC CORP. LTD., Shenzhen (CN)

(72) Inventor: Chin-Fu Chen, Hsinchu County (TW)

(73) Assignee: ARK MICROELECTRONIC CORP. LTD., Shenzhen (CN)

(21) Appl. No.: 18/518,587

(22) Filed: Nov. 23, 2023

(30) Foreign Application Priority Data
Jan. 17, 2023 (CN) 202310095025.3

(51) Int. Cl. H02M 7/217

(52) U.S. Cl. CPC H02M 7/217

(57) ABSTRACT

A power conversion circuit, a power conversion system, a power source and a method and a device of controlling the same are provided. The power conversion circuit includes an AC/DC rectifier circuit, a DC/DC conversion circuit and an energy storing circuit coupled between the AC/DC rectifier circuit and the DC/DC conversion circuit. The energy storing circuit includes a first capacitor, a second capacitor and a switch. The first capacitor and the second capacitor are coupled in series. The switch is coupled in parallel with the second capacitor. The switch is configured to turn on when the output voltage of the AC/DC rectifier circuit is smaller than or equal to a threshold value; and turn off when the output voltage of the AC/DC rectifier circuit is larger than the threshold value, wherein the threshold value is smaller than or equal to the rated voltage of the first capacitor.

### BACKGROUND OF THE INVENTION

### 1. Field of the Invention

The present invention is related to an electronic device, and more particularly, to a power conversion circuit, a power conversion system, and a method of controlling the same.

### 2. Description of the Prior Art

A common power conversion circuit includes an AC/DC rectifier circuit, a DC/DC conversion circuit, and an energy storage circuit coupled between the AC/DC rectifier circuit and the DC/DC conversion circuit. The energy storage circuit is used to reduce or even eliminate ripple voltage in the rectified voltage output by the AC/DC rectifier circuit.

In order to meet application requirements, such power conversion circuit requires an input voltage suitable for a certain range of the AC/DC rectifier circuit, that is, AC voltage. For example, the applicable input voltage range of the power conversion circuit is from 85V to 265V. For another example, the applicable input voltage range of the power conversion circuit is from 110V to 220V. In order to be suitable for the minimum input voltage, the overall capacitance value of the capacitors in the energy storage circuit needs to be sufficiently large. In order to be able to be suitable for the maximum input voltage, the overall rated voltage of the capacitors in the energy storage circuit (i.e., the maximum voltage each capacitor can withstand, or the maximum voltage that can be dropped across each capacitor safely without destroying it) also needs to be sufficiently large.

Since the size and the cost of a single capacitor increase with its rated voltage and its capacitance value, in a related prior art technique (e.g., referring to the China patent publication No. CN101414764A), the energy storage circuit includes two capacitors coupled in parallel for reducing the overall size and overall cost of the capacitors in the energy storage circuit. More specifically, these two capacitors in a parallel configuration include a capacitor with a larger voltage rating (usually referred to as a high-voltage capacitor) and a capacitor with a smaller voltage rating (usually referred to as a low-voltage capacitor). The low-voltage capacitor is coupled in series to a switch to form an energy charging storage path, and the two ends of the energy charging storage path are coupled in parallel with the high-voltage capacitor.

When the switch is turned off, only the high-voltage capacitor among the two capacitors in a parallel configuration is able to operate. Under such circumstance, the capacitors in the energy storage circuit have the largest overall rated voltage, and the energy storage circuit is suitable for a larger input voltage in the input voltage range (hereinafter referred to as high voltage, including the maximum input voltage) in the input voltage range.

When the switch is turned on, both the high-voltage capacitor and the low-voltage capacitor are able to operate. Under such circumstance, the capacitors in the energy storage circuit has the largest overall capacitance value, and the energy storage circuit is suitable for a smaller input voltage (hereinafter referred to as low voltage, including the minimum input voltage) in the input voltage range.

### SUMMARY OF THE INVENTION

The present invention provides a power conversion circuit which includes an AC/DC rectifier circuit, a DC/DC conversion circuit and an energy storing circuit coupled between the AC/DC rectifier circuit and the DC/DC conversion circuit. The energy storing circuit includes a first capacitor, a second capacitor and a switch. The first capacitor and the second capacitor are coupled in series. The second capacitor has a first capacitor end and a second capacitor end. The switch includes a first switch end coupled to the capacitor first end and a second switch end coupled to the second capacitor end. The switch is configured to operate in a conduction state when an output voltage of the AC/DC rectifier circuit is smaller than or equal to a threshold value; and operate in a non-conduction state when the output voltage of the AC/DC rectifier circuit is larger than the threshold value, wherein the threshold value is smaller than or equal to a rated voltage of the first capacitor.

The present invention also provides a method of controlling a power conversion circuit which includes an AC/DC rectifier circuit, a DC/DC conversion circuit and an energy storing circuit coupled between the AC/DC rectifier circuit and the DC/DC conversion circuit. The energy storing circuit includes a first capacitor, a second capacitor coupled in series to the first capacitor and a switch coupled in parallel with the second capacitor. The method includes operating the switch in a conduction state when an output voltage of the AC/DC rectifier circuit is smaller than or equal to a threshold value; and operating the switch in a non-conduction state when the output voltage of the AC/DC rectifier circuit is larger than the threshold value, wherein the threshold value is smaller than or equal to a rated voltage of the first capacitor.

The present invention also provides a power converting system which includes a power conversion circuit and a control device or a control circuit. The power conversion circuit includes an AC/DC rectifier circuit, a DC/DC conversion circuit and an energy storing circuit coupled between the AC/DC rectifier circuit and the DC/DC conversion circuit. The energy storing circuit includes a first capacitor, a second capacitor and a switch. The first capacitor and the second capacitor are coupled in series. The second capacitor has a first capacitor end and a second capacitor end. The switch includes a first switch end coupled to the first capacitor end and a second switch end coupled to the second capacitor end. The control circuit is configured to control the switch to operate in a conduction state when an output voltage of the AC/DC rectifier circuit is smaller than or equal to a threshold value; and control the switch to operate in a non-conduction state when the output voltage of the AC/DC rectifier circuit is larger than the threshold value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a power conversion circuit according to an embodiment of the present invention.

FIG. 2 is a diagram illustrating a power conversion circuit according to another embodiment of the present invention.

FIG. 3 is a flowchart illustrating a method of controlling the power conversion circuit according to an embodiment of the present invention.

FIG. 4 is a diagram illustrating a power conversion system according to an embodiment of the present invention.

### DETAILED DESCRIPTION

The following disclosure provides many different embodiments, or examples, for implementing different features of the disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “under,” “lower,” “over,” “above,” “on,” “upper” and the like, may be used herein for ease of description to describe one element or feature's relationship to another element (s) or feature (s) as illustrated in the figures. The spatially relative terms are intended to encompass different orientations of the device in use or operation in addition to the orientation depicted in the figures. For example, if the device in the figures is turned over, elements described as “below” and/or “beneath” other elements or features would then be oriented “above” and/or “over” the other elements or features. The apparatus may be otherwise oriented (rotated 90 degrees or at other orientations) and the spatially relative descriptors used herein may likewise be interpreted accordingly.

It is understood that, although the terms first, second, third, etc. may be used herein to describe various elements, components, regions, layers and/or sections, these elements, components, regions, layers and/or sections should not be limited by these terms. These terms may be only used to distinguish one element, component, region, layer and/or section from another region, layer and/or section. Terms such as “first,” “second,” and other numerical terms when used herein do not imply a sequence or order unless clearly indicated by the context. Thus, a first element, component, region, layer and/or section discussed below could be termed a second element, component, region, layer and/or section without departing from the teachings of the embodiments. As disclosed herein, the term “about” or “substantial” generally means within 208, 10%, 5%, 38, 28, 1%, or 0.5% of a given value or range. Unless otherwise expressly specified, all of the numerical ranges, amounts, values and percentages disclosed herein should be understood as modified in all instances by the term “about” or “substantial”. Accordingly, unless indicated to the contrary, the numerical parameters set forth in the present disclosure and attached claims are approximations that can vary as desired.

Furthermore, as disclosed herein, the terms “coupled to” and “electrically connected to” include any directly and indirectly electrical connecting means. Therefore, if it is described in this document that a first component is coupled or electrically connected to a second component, it means that the first component may be directly connected to the second component, or may be indirectly connected to the second component through other components or other connecting means.

Although the disclosure is described with respect to specific embodiments, the principles of the disclosure, as defined by the claims appended herein, can obviously be applied beyond the specifically described embodiments of the disclosure described herein. Moreover, in the description of the present disclosure, certain details have been left out in order to not obscure the inventive aspects of the disclosure. The details left out are within the knowledge of a person having ordinary skill in the art.

The prior art energy storage circuit includes capacitors with large sizes and high costs, thereby resulting in a larger overall size and higher overall cost of the power conversion circuit.

Based on analysis, when two capacitors are coupled in a parallel configuration, the voltage rating of at least one capacitor needs to be larger than or essentially equal to the maximum input voltage suitable for the power conversion circuit. Such high-voltage capacitor increases the overall size and overall cost of the capacitors in the power conversion circuit.

The present invention is therefore aimed at reducing the overall size and overall cost of the capacitors in the power conversion circuit, thereby reducing the overall size and overall cost of the power conversion circuit.

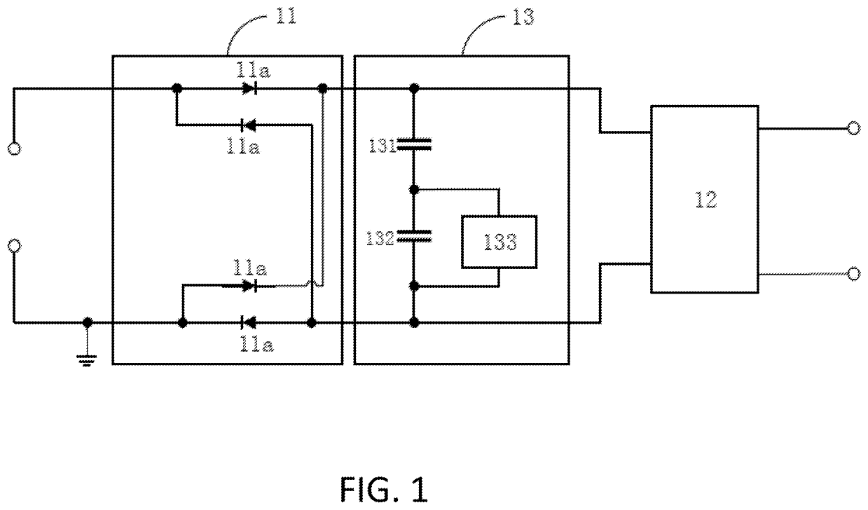

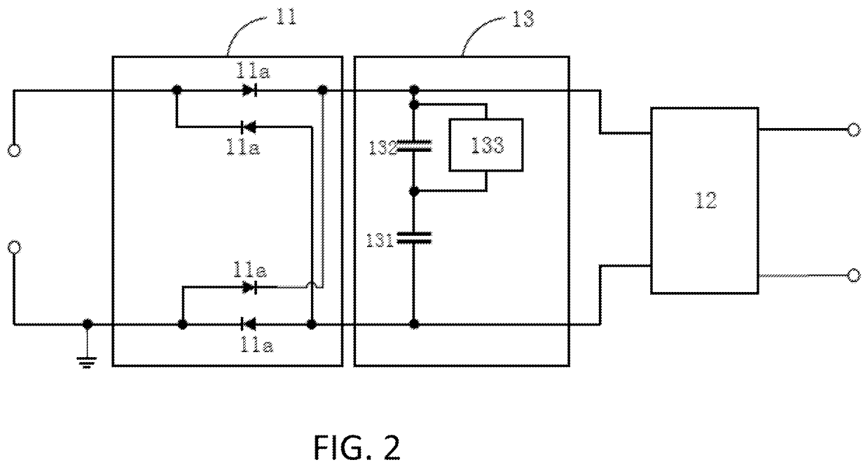

FIG. 1 is a diagram illustrating a power conversion circuit according to an embodiment of the present invention. FIG. 2 is a diagram illustrating a power conversion circuit according to another embodiment of the present invention. As depicted in FIGS. 1 and 2, each power conversion circuit includes an AC/DC rectifier circuit 11, a DC/DC conversion circuit 12 and an energy storing circuit 13 coupled between the AC/DC rectifier circuit 11 and the DC/DC conversion circuit 12.

In some embodiments, the AC/DC rectifier circuit 11 includes one or multiple rectifier devices 11a. For example as depicted in FIGS. 1 and 2, the AC/DC rectifier circuit 11 may be a bridge rectifier circuit 11 which includes four rectifier devices 11a. Each rectifier device 11a may be a diode or a metal-oxide-semiconductor field-effect transistor (MOSFET), but is not limited thereto.

In some other embodiments, the DC/DC conversion circuit 12 includes a switching power supply (SPS) circuit.

In some embodiments, the energy storing circuit 13 includes a first capacitor 131 and a second capacitor 132 coupled in series. The first capacitor 131 and the second capacitor 132 are coupled in series between a first output end and a second output end of the AC/DC rectifier circuit 11. That is, the first capacitor 131 and the second capacitor 132 are coupled in series between a first input end and a second input end of the DC/DC conversion circuit 12.

The energy storing circuit 13 further includes a switch 133 coupled in parallel with the second capacitor 132. More specifically, the switch 133 includes a first switch end coupled to a first capacitor end of the second capacitor 132 and a second switch end coupled to a second capacitor end of the second capacitor 132. The switch 133 may be a MOSFET, such as an N-type MOSFET or a P-type MOSFET, but is not limited thereto.

The first switch end of the switch 133 is coupled to a node between the first capacitor 131 and the second capacitor 132. The second switch end of the switch 133 is coupled to one of the first output end and the second output end of the AC/DC rectifier circuit 11. FIG. 1 depicts the embodiment when the second switch end of the switch 133 is coupled to the first output end of the AC/DC rectifier circuit 11 which is coupled to ground. FIG. 2 depicts the embodiment when the second switch end of the switch 133 is coupled to the second output end of the AC/DC rectifier circuit 11 which is used to output DC voltages.

In some embodiments, the switch 133 is configured to operate in a conduction state with lower resistance when the output voltage of the AC/DC rectifier circuit 11 is smaller than or equal to a threshold value, and is configured to operate in a non-conduction state when the output voltage of the AC/DC rectifier circuit 11 is larger than the threshold value, wherein the threshold value is smaller than or equal to the rated voltage of the first capacitor 131.

In the situation when the switch 133 operates in the conduction state with lower resistance, both ends of the second capacitor 132 is short-circuited, so the output current from the AC/DC rectifier circuit 11 will flow through the first capacitor 131 and the switch 133, but will not flow through the second capacitor 132. Under such circumstance, only the first capacitor 131 can function to receive and store electric charge from the AC/DC rectifier circuit 11, and the energy storing circuit 13 has the largest overall capacitance value (i.e., equal to the capacitance value of the first capacitor 131) and the smallest overall rated voltage (i.e., equal to the rated voltage of the first capacitor 131). Therefore, when the output voltage of the AC/DC rectifier circuit 11 has a low voltage level, the energy storing circuit 13 is able to effectively reduce ripple voltages in the output voltage of the AC/DC rectifier circuit 11, thereby improving the conversion efficiency of the DC/DC conversion circuit 12 of the next stage.

In the situation when the switch 133 operates in the non-conduction state, the output current from the AC/DC rectifier circuit 11 will flow through both the first capacitor 131 and the second capacitor 132. Under such circumstance, both the first capacitor 131 and the second capacitor 132 can function to receive and store electric charge from the AC/DC rectifier circuit 11, and the energy storing circuit 13 has the smallest overall capacitance value (i.e., equal to the capacitance value of the first capacitor 131 and the capacitance value of the second capacitor 132 in a series configuration) and the largest overall rated voltage (i.e., equal to sum of the rated voltages of the first capacitor 131 and the second capacitor 132 in a series configuration). Therefore, when the output voltage of the AC/DC rectifier circuit 11 has a high voltage level, the energy storing circuit 13 is able to reduce the possibility of the first capacitor 131 being punched through by the high threshold value, thereby improving the reliability of the power conversion circuit.

It is to be understood that in the situation when the switch 133 operates in the non-conduction state and the first capacitor 131 and the second capacitor 132 are coupled in series, the overall rated voltage of the capacitors in the energy storing circuit 13 is larger than either the rated voltage of the first capacitor 131 or the rated voltage of the second capacitor 132. Also, the overall capacitance value of the capacitors in the energy storing circuit 13 is smaller than either the capacitance value of the first capacitor 131 or the capacitance value of the second capacitor 132.

In other words, compared to a prior art power conversion circuit with the same overall rated voltage and the same overall capacitance value, the power conversion circuit of the present invention can provide the first capacitor 131 and the second capacitor 132 each having larger capacitance value but a smaller rated voltage. Since the size and the cost of a single capacitor is affected much more by its rated voltage than by its capacitance value, the present invention can reduce the overall size and the overall cost of the capacitors in the energy storing circuit 13 by disposing the first capacitor 131 and the second capacitor 132 coupled in series in the energy storing circuit 13.

In the power conversion circuit of the above-mentioned embodiment, the energy storing circuit 13 coupled between the AC/DC rectifier circuit 11 and the DC/DC conversion circuit 12 includes the first capacitor 131 and the second capacitor 132 coupled in series, wherein the two capacitor ends of the second capacitor 132 are respectively coupled to the two switch ends of the switch 133. The switch 133 is configured to operate in the conduction state with lower resistance when the output voltage of the AC/DC rectifier circuit 11 is smaller than or equal to the threshold value, and is configured to operate in the non-conduction state when the output voltage of the AC/DC rectifier circuit 11 is larger than the threshold value. This way, the maximum input voltage suitable for the power conversion circuit may be larger than either the rated voltage of the first capacitor 131 or the rated voltage of the second capacitor 132 (i.e., the rated voltage of the first capacitor 131 and the rated voltage of the second capacitor 132 are both smaller than the maximum input voltage suitable for the power conversion circuit). Therefore, the present invention can reduce the overall size and the overall cost of the capacitors in the energy storing circuit 13, thereby reducing the overall size and the overall cost of the power conversion circuit.

In order to better illustrate the benefits of the present invention, the following Table 1 and Table 2 are used for explanation. Table 1 depicts related parameters of two capacitors C1 and C2 in a prior art power conversion circuit. Table 2 depicts related parameters of the first capacitor 131 and the second capacitor 132 according to an embodiment of the present invention.

TABLE 1

| | Diameter | length | size | capacitance | rated voltage |
|---|---|---|---|---|---|
| | (mm) | (mm) | (mm³) | value (uF) | (V) |
| C1 | 10 | 20 | 1570 | 33 | 200 |
| C2 | 16 | 20 | 4019.2 | 33 | 400 |

In the prior art power conversion circuit, the capacitor C1 is coupled in parallel with a switch to form a branch circuit which is coupled in parallel with the capacitor C2. When the output voltage of the prior art AC/DC rectifier circuit has a high voltage level, the switch is turned off, and only the capacitor C2 is able to function. Under such circumstance, the capacitors in the prior art energy storing circuit has an overall rated voltage of 400V and an overall capacitance value of 33 uF. When the output voltage of the prior art AC/DC rectifier circuit has a low voltage level, the switch is configured to operates in the conduction state with lower resistance, and the capacitor C1 is coupled in parallel with the capacitor C2. Under such circumstance, the capacitors in the prior art energy storing circuit has an overall rated voltage of 200V and an overall capacitance value of 66 uF.

In the prior art power conversion circuit, the overall size of the capacitors C1 and C2 is 5589.2 mm³, and the overall cost of the capacitors C1 and C2 is 3.17 USD.

TABLE 2

| | Diameter | length | size | capacitance | rated |
|---|---|---|---|---|---|
| | (mm ) | (mm) | (mm³) | value (uF) | voltage (V) |
| C1 | 12.5 | 20 | 2453 | 68 | 200 |
| C2 | 12.5 | 20 | 2453 | 68 | 200 |

In the present power conversion circuit, the first capacitor 131 is coupled in series to the second capacitor 132, and the switch 133 is coupled in parallel with the second capacitor 132. When the output voltage of the AC/DC rectifier circuit 11 has a low voltage level, the switch 133 operates in the conduction state with lower resistance, and only the first capacitor 131 is able to function. Under such circumstance, the capacitors in the energy storing circuit 133 has an overall rated voltage of 200V and an overall capacitance value of 68 uF (larger than 66 uF in the prior art). When the output voltage of the AC/DC rectifier circuit 11 has a high voltage level, the switch 133 operates in the non-conduction state, and the first capacitor 131 and the second capacitor 132 are both able to function. Under such circumstance, the capacitors in the energy storing circuit 13 has an overall rated voltage of 400V and an overall capacitance value of 34 uF (larger than 33 uF in the prior art).

In the present power conversion circuit, the overall size of the first capacitor 131 and the second capacitor 132 is 4906 mm³, and the overall cost of the first capacitor 131 and the second capacitor 132 is 2.73 USD.

It can be seen that with the same overall rate voltage and larger overall capacitance value, the present invention can adopt first capacitor 131 and the second capacitor 132 with a smaller overall size and lower overall cost (as depicted in Table 2) than the capacitors C1 and C2 in the prior art power conversion circuit (as depicted in Table 1). The present power conversion circuit and the prior art power conversion circuit may be suitable for the same range of AC input voltage (e.g., 110V-220V).

It is to be understood that the rated voltage and the capacitance value of each of the first capacitor 131 and the second capacitor 132 may be designed based on the application scenario of the power conversion circuit.

For example, the rated voltage of the first capacitor 131 may be designed based on the minimum input voltage suitable for the power conversion circuit, and the rated voltage of the second capacitor 132 may be designed based on the maximum input voltage suitable for the power conversion circuit. In some embodiments, the rated voltage of the first capacitor 131 is larger than or essentially equal to the minimum input voltage suitable for the power conversion circuit. In some other embodiments, the overall rated voltage of the first capacitor 131 and the second capacitor 132 coupled in series is larger than or essentially equal to the maximum input voltage suitable for the power conversion circuit. In some other embodiments, the rated voltage of the first capacitor 131 is equal to the rated voltage of the second capacitor 132.

In some embodiments, the first capacitor 131 and the second capacitor 132 may adopt the same type of capacitor. That is, the rated voltage of the first capacitor 131 is equal to the rated voltage of the second capacitor 132, and the capacitance value of the first capacitor 131 is equal to the capacitance value of the second capacitor 132.

This way, the first capacitor 131 and the second capacitor 132 may have similar impedance which allows the high output voltage of the AC/DC rectifier circuit 11 to be evenly distributed among the first capacitor 131 and the second capacitor 132. Also, the manufacturing process of the AC/DC rectifier circuit 11 may be simplified, thereby simplifying the manufacturing process of the energy storing circuit 13. Meanwhile, the overall cost of the capacitors in the energy storing circuit 13 may be reduced, thereby reducing the overall cost of the power conversion circuit.

For example, during the manufacturing process of the energy storing circuit 13, since the two capacitors have the same rate voltage and the same capacitance value, the two ends of the switch 133 may be coupled to the two ends of any of the first capacitor 131 and the second capacitor 132 instead of identifying the second capacitor 132 from the two capacitors. This way, the manufacturing process of the energy storing circuit 13 may be simplified, thereby simplifying the manufacturing process of the power conversion circuit.

For another example, since the first capacitor 131 and the second capacitor 132 have the same rate voltage and the same capacitance value, the manufacturer of the power conversion circuit can produce capacitance of the same specification in a larger quantity and thus lower the unit price of each capacitor. This way, the overall cost of the capacitors in the energy storing circuit 13 may be reduced, thereby reducing the overall cost of the power conversion circuit.

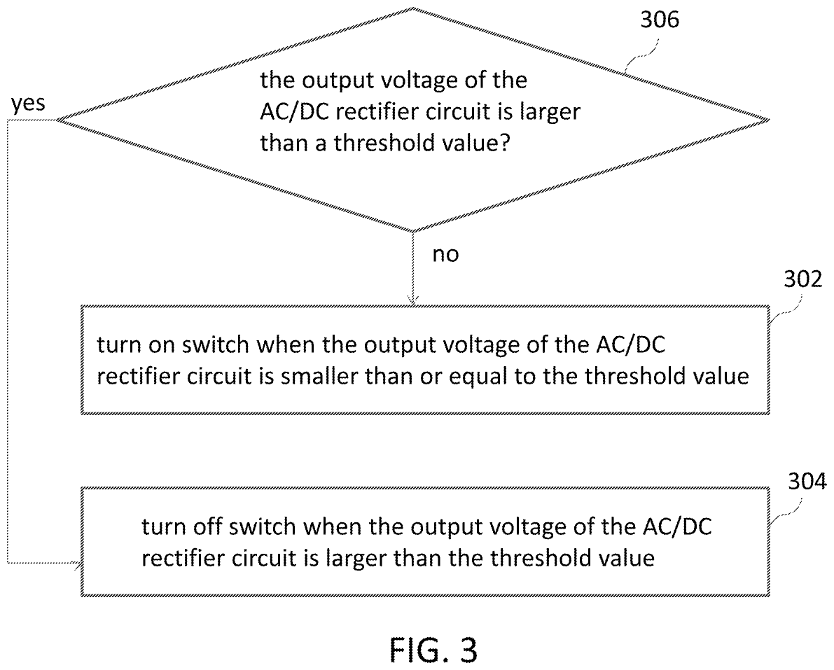

FIG. 3 is a flowchart illustrating a method of controlling the power conversion circuit according to an embodiment of the present invention.

As depicted in FIGS. 1 and 2, the power conversion circuit includes an AC/DC rectifier circuit 11, a DC/DC conversion circuit 12 and an energy storing circuit 13 coupled between the AC/DC rectifier circuit 11 and the DC/DC conversion circuit 12. The energy storing circuit 13 includes a first capacitor 131 and a second capacitor 132 coupled in series. The energy storing circuit 13 further includes a switch 133 coupled in parallel with the second capacitor 132.

As depicted in FIG. 3, the present method of controlling the power conversion circuit includes steps 302-304.

In step 302, the switch 133 is configured to operate in the conduction state with lower resistance when the output voltage of the AC/DC rectifier circuit 11 is smaller than or equal to a threshold value, wherein the threshold value is smaller than or equal to the rated voltage of the first capacitor 131.

In step 304, the switch 133 is configured to operate in the non-conduction state when the output voltage of the AC/DC rectifier circuit 11 is larger than the threshold value.

In some embodiments as depicted in FIG. 3, the present method of controlling the power conversion circuit further includes step 306. In step 306, it is determined whether the output voltage of the AC/DC rectifier circuit 11 is larger than the threshold value. When it is determined that the output voltage of the AC/DC rectifier circuit 11 is not larger than the threshold value, the present method loops back to step 302; When it is determined that the output voltage of the AC/DC rectifier circuit 11 is larger than the threshold value, the present method loops back to step 304.

In some embodiments, by operating the switch 133 in the conduction state with lower resistance when the output voltage of the AC/DC rectifier circuit 11 is smaller than or equal to the threshold value, the overall capacitance value of the capacitors in the energy storing circuit 13 may be adjusted to its maximum value in time when the output voltage of the AC/DC rectifier circuit 11 is smaller than or equal to the threshold value. By operating the switch 133 in the non-conduction state when the output voltage of the AC/DC rectifier circuit 11 is larger than the threshold value, the overall rated voltage of the capacitors in the energy storing circuit 13 may be adjusted to its maximum value in time when the output voltage of the AC/DC rectifier circuit 11 is larger than the threshold value. This way, when the output voltage of the AC/DC rectifier circuit 11 has a low voltage level, the energy storing circuit 13 is able to effectively reduce ripple voltages in the output voltage of the AC/DC rectifier circuit 11, thereby improving the conversion efficiency of the DC/DC conversion circuit 12 of the next stage. When the output voltage of the AC/DC rectifier circuit 11 has a high voltage level, the energy storing circuit 13 is able to reduce the possibility of the first capacitor 131 being punched through by the high threshold value, thereby improving the reliability of the power conversion circuit.

In some embodiments, the output voltage of the AC/DC rectifier circuit 11 may be acquired, and the switch 133 is configured to selectively operate in the conduction state or the non-conduction state based on whether the acquired output voltage of the AC/DC rectifier circuit 11 exceeds the threshold value. This way, the operation of the switch 133 may be controlled by directly acquiring the output voltage of the AC/DC rectifier circuit 11.

It is to be understood that in addition to acquiring the output voltage of the AC/DC rectifier circuit 11, other methods may be adopted for determining whether the output voltage of the AC/DC rectifier circuit 11 is larger than the threshold value. The present invention is not limited thereto.

An embodiment of the present invention further provides a control device of the power conversion circuit.

As depicted in FIGS. 1 and 2, the power conversion circuit includes an AC/DC rectifier circuit 11, a DC/DC conversion circuit 12 and an energy storing circuit 13 coupled between the AC/DC rectifier circuit 11 and the DC/DC conversion circuit 12. The energy storing circuit 13 includes a first capacitor 131 and a second capacitor 132 coupled in series. The energy storing circuit 13 further includes a switch 133 coupled in parallel with the second capacitor 132.

In some embodiments, the power conversion circuit further includes a control module. The control module is configured to operate the switch 133 in the conduction state with lower resistance when the output voltage of the AC/DC rectifier circuit 11 is smaller than or equal to the threshold value, and is configured to operate the switch 133 in the non-conduction state when the output voltage of the AC/DC rectifier circuit 11 is larger than the threshold value, wherein the threshold value is smaller than or equal to the rated voltage of the first capacitor 131.

It is to be understood that in the above-mentioned embodiment, the power conversion circuit may further include another type of control module for executing the method of controlling the power conversion circuit in any of the above-mentioned embodiments.

In some embodiments, the power conversion circuit further includes a storage device and a processor coupled to the storage device. The processor is configured to execute the method of controlling the power conversion circuit in any of the above-mentioned embodiments based on the commands stored in the storage device.

In some embodiments, the storage device may include a system storage device or non-volatile memory. For example, the system storage device may store operation systems, application procedures, boot loader and other procedures.

Another embodiment of the present invention further provides a power conversion system.

In some embodiments, the power conversion system includes a power conversion circuit in any of the above-mentioned embodiments and a control device of the power conversion circuit in any of the above-mentioned embodiments.

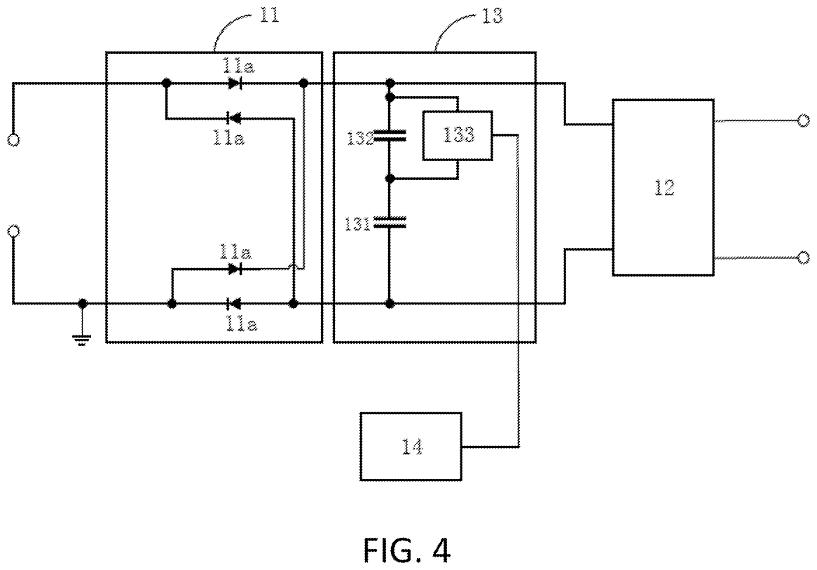

In some other embodiments as depicted in FIG. 4, the power conversion system includes a power conversion circuit in any of the above-mentioned embodiments and a control circuit 14. The control circuit 14 is configured to operate the switch 133 in the conduction state with lower resistance when the output voltage of the AC/DC rectifier circuit 11 is smaller than or equal to the threshold value, and is configured to operate the switch 133 in the non-conduction state when the output voltage of the AC/DC rectifier circuit 11 is larger than the threshold value.

In some embodiments, the control circuit 14 is further configured to acquire the output voltage of the AC/DC rectifier circuit 11 and control the operation of the switch 133 based on the acquired output voltage of the AC/DC rectifier circuit 11.

For example, the control circuit 14 is configured to be coupled to the output ends of the AC/DC rectifier circuit 11 for acquiring the output voltage of the AC/DC rectifier circuit 11. For another example, the control circuit 14 is configured to be coupled to the input ends of the DC/DC conversion circuit 12 for acquiring the output voltage of the AC/DC rectifier circuit 11.

The control circuit 14 may also be configured to perform other procedures for executing the method of controlling the power conversion circuit in any of the above-mentioned embodiments. Similar operations of the control circuit 14 are omitted.

Another embodiment of the present invention further provides a power source which includes the power conversion circuit in any of the above-mentioned embodiments. The power source may be used in any electronic device such as a smart phone or a computer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power conversion circuit, comprising:
an AC/DC rectifier circuit;
a DC/DC conversion circuit; and
an energy storing circuit coupled between the AC/DC rectifier circuit and the DC/DC conversion circuit, and comprising:
a first capacitor;
a second capacitor coupled in series with the first capacitor and having a first capacitor end and a second capacitor end;
a switch including a first switch end coupled to the first capacitor end and a second switch end coupled to the second capacitor end, wherein:
the switch operates in a conduction state when an output voltage of the AC/DC rectifier circuit is smaller than or equal to a threshold value; and
the switch operates in a non-conduction state when the output voltage of the AC/DC rectifier circuit is larger than the threshold value, wherein the threshold value is smaller than or equal to a rated voltage of the first capacitor.

2. The power conversion circuit of claim 1, wherein a capacitance value of the first capacitor is equal to a capacitance value of the second capacitor.

3. The power conversion circuit of claim 1, wherein the rated voltage of the first capacitor is equal to a rated voltage of the second capacitor.

4. The power conversion circuit of claim 1, wherein when the switch is in the conduction state, an output current from the AC/DC rectifier circuit flows through the first capacitor and the switch, and does not flow through the second capacitor.

5. The power conversion circuit of claim 4, wherein an overall capacitance value of the energy storing circuit is equal to a capacitance value of the first capacitor, and an overall rated voltage of the energy storing circuit is equal to the rated voltage of the first capacitor.

6. The power conversion circuit of claim 1, wherein when the switch is in the non-conduction state, an output current from the AC/DC rectifier circuit flows through both the first capacitor and the second capacitor.

7. The power conversion circuit of claim 6, wherein an overall capacitance value of the energy storing circuit is equal to a capacitance value of the first capacitor and a capacitance value of the second capacitor in a series configuration.

8. The power conversion circuit of claim 6, wherein an overall rated voltage of the energy storing circuit is equal to a sum of the rated voltage of the first capacitor and a rated voltage of the second capacitor.

9. A method of controlling a power conversion circuit which includes an AC/DC rectifier circuit, a DC/DC conversion circuit and an energy storing circuit coupled between the AC/DC rectifier circuit and the DC/DC conversion circuit, the energy storing circuit comprising a first capacitor, a second capacitor coupled in series to the first capacitor and a switch coupled in parallel with the second capacitor, the method comprising:
operating the switch in a conduction state when an output voltage of the AC/DC rectifier circuit is smaller than or equal to a threshold value; and
operating the switch in a non-conduction state when the output voltage of the AC/DC rectifier circuit is larger than the threshold value, wherein the threshold value is smaller than or equal to a rated voltage of the first capacitor.

10. The method of claim 9, further comprising:
acquiring the output voltage of the AC/DC rectifier circuit.

11. The method of claim 9, wherein a capacitance value of the first capacitor is equal to a capacitance value of the second capacitor.

12. The method of claim 9, wherein the rated voltage of the first capacitor is equal to a rated voltage of the second capacitor.

13. A power conversion system, comprising:
a power conversion circuit comprising:
an AC/DC rectifier circuit;
a DC/DC conversion circuit; and
an energy storing circuit coupled between the AC/DC rectifier circuit and the DC/DC conversion circuit, and comprising:
a first capacitor;
a second capacitor coupled in series with the first capacitor and having a first capacitor end and a second capacitor end; and
a switch including a first switch end coupled to a first capacitor end and a second switch end coupled to the second capacitor end; and
a control device comprising a control module configured to:
control the switch to operate in a conduction state when an output voltage of the AC/DC rectifier circuit is smaller than or equal to a threshold value; and
control the switch to operate in a non-conduction state when the output voltage of the AC/DC rectifier circuit is larger than the threshold value.

14. The power conversion system of claim 13, wherein the control device is further configured to acquire the output voltage of the AC/DC rectifier circuit.

15. The power conversion system of claim 13, wherein when the switch is in the conduction state, an output current from the AC/DC rectifier circuit flows through the first capacitor and the switch, and does not flow through the second capacitor.

16. The power conversion system of claim 15, wherein an overall capacitance value of the energy storing circuit is equal to a capacitance value of the first capacitor, and an overall rated voltage of the energy storing circuit is equal to a rated voltage of the first capacitor.

17. The power conversion system of claim 13, wherein when the switch is in the non-conduction state, an output current from the AC/DC rectifier circuit flows through both the first capacitor and the second capacitor.

18. The power conversion system of claim 17, wherein an overall capacitance value of the energy storing circuit is equal to a capacitance value of the first capacitor and a capacitance value of the second capacitor in a series configuration.

19. The power conversion system of claim 17, wherein an overall rated voltage of the energy storing circuit is equal to a sum of a rated voltage of the first capacitor and a rated voltage of the second capacitor.
